(19) United States
(12) Patent Application Publication
(10) Pub. No.: US 2014/0176609 A1
(43) Pub. Date: Jun. 26, 2014

(54) MIXED REALITY APPARATUS

(71) Applicant: PIONEER CORPORATION, Kawasaki-shi, Kanagawa (JP)

(72) Inventor: Akira Gotoda, Kawasaki-shi (JP)

(21) Appl. No.: 14/236,767

(22) PCT Filed: Aug. 9, 2011
(86) PCT No.: PCT/JP2011/068136

§ 371 Date: Feb. 12, 2014

(51) Int. Cl. G02B 27/01; G06T 11/60

(52) U.S. Cl. CPC G02B 27/0179; G06T 11/60
USPC 345/633

(57) ABSTRACT

A mixed reality device is provided with: a head-mounted display (100) that has a mounting section (110) to be mounted on a user's head, specified position detection means (120 and 231) that detect a specified position in the real environment, and a display section (130) that displays superimposition information to be superimposed onto the real environment; a mounting condition detection means (140) that detects the mounting condition of the mounting section; and update process means (210 and 220) that according to the mounting condition detected by the mounting condition detection means, updates calibration data used to transform the coordinate system of the specified position detection means to the coordinate system of the display section.

### TECHNICAL FIELD

The present invention relates to, for example, an optical transmission type mixed reality apparatus.

### BACKGROUND ART

There is known a mixed reality (MR) apparatus which additionally presents information such as, for example, computer graphics (CG) and letters, to a reality environment (e.g. refer to Non-Patent document 1). Mixed reality is also referred to as augment reality (AR) in some cases, in the sense of amplifying information owned by the reality environment.

The mixed reality apparatus has a video transmission type (or a video see-through type) and an optical transmission type (or an optical see-through type). The video transmission type mixed reality apparatus, for example, combines CG with an image of the reality environment which is taken by a camera mounted on a head mounted display (HMD) and then displays the CG-combined image on the HMD. On the other hand, the optical transmission type mixed reality apparatus, for example, detects a specific position (e.g. a marker position) of the reality environment on the basis of the image taken by the camera mounted on the HMD and displays CG on the HMD to look like the detected specific position, thereby combining the CG with the reality environment (e.g. refer to Non-Patent document 1).

For example, the Non-Patent document 1 discloses a technology regarding calibration of an information display position on the HMD in the optical transmission type mixed reality apparatus.

Incidentally, for example, Patent document 1 discloses a technology in which the presence or absence of a mounted HMD is detected to change ON/OFF of a power supply of the HMD.

### PRIOR ART DOCUMENT

### Patent Document

Patent document 1: Japanese Patent Application Laid Open No. 2000-278713

Non-Patent Document

Non-Patent document 1: Kato, H., Billinghurst M. Asano. K., and Tachibana, K. “An augmented reality system and its calibration based on marker tracking”, Transactions of the Virtual Reality Society of Japan 4.4 (1999), pp 607-616

### DISCLOSURE OF INVENTION

### Subject to be Solved by the Invention

The optical transmission type mixed reality apparatus as described above has such a technical problem that a relation between the specific position of the reality environment and the information display position on the HMD likely changes if the mounting state of the HMD changes. Thus, there is a possibility that the mixed reality cannot be preferably realized if the mounting state of the HMD changes.

In view of the aforementioned conventional problems, it is therefore an object of the present invention to provide, for example, a mixed reality apparatus which is configured to preferably realize the mixed reality.

### Means for Solving the Subject

The above object of the present invention can be solved by a mixed reality apparatus comprising: a head mounted display having a mounting unit which is mounted on a head of a user, a specific position detecting device which is configured to detect a specific position of a reality environment, and a display unit which is configured to display additional information to be added to the reality environment; a mounting state detecting device which is configured to detect a mounting state of the mounting unit; and an updating device which is configured to perform updating of calibration data for performing transformation from a coordinate system of the specific position detecting device to a coordinate system of the display unit, in accordance with the mounting state detected by said mounting state detecting device.

The operation and other advantages of the present invention will become more apparent from an embodiment explained below.

### BRIEF DESCRIPTION OF DRAWINGS

FIG. 1 is an outside view (1) illustrating a schematic configuration of a mixed reality apparatus in a first embodiment.

FIG. 2 is an outside view (2) illustrating the schematic configuration of the mixed reality apparatus in the first embodiment.

FIG. 3 is a block diagram illustrating a configuration of the mixed reality apparatus in the first embodiment.

FIG. 4 is a block diagram illustrating a configuration of a DB control unit in the first embodiment.

FIG. 5 is a block diagram illustrating a configuration of a calibration unit in the first embodiment.

FIG. 6 is a block diagram illustrating a configuration of a transformation matrix calculation unit in the first embodiment.

FIG. 7 is a block diagram illustrating a configuration of a rendering unit in the first embodiment.

FIG. 8 is a flowchart illustrating a flow of the operation of the mixed reality apparatus in the first embodiment.

FIG. 9 is a flowchart illustrating a flow of pressure-distribution-associated calibration in the first embodiment.

FIG. 10 are diagrams for explaining calibration in an optical transmission type mixed reality apparatus.

### MODES FOR CARRYING OUT THE INVENTION

The above object of the present invention can be solved by a mixed reality apparatus comprising: a head mounted display having a mounting unit which is mounted on a head of a user, a specific position detecting device which is configured to detect a specific position of a reality environment, and a display unit which is configured to display additional information to be added to the reality environment; a mounting state detecting device which is configured to detect a mounting state of the mounting unit; and an updating device which is configured to perform updating of calibration data for performing transformation from a coordinate system of the specific position detecting device to a coordinate system of the display unit, in accordance with the mounting state detected by said mounting state detecting device.

The mixed reality apparatus of the present invention is an optical transmission type mixed reality apparatus in which the head mounted display (more specifically, the mounting unit thereof) is used while being mounted on the head of the user and in which the additional information is displayed on the display unit having optical transparency so that the mixed reality is realized. In other words, according to the mixed reality apparatus of the present invention, in operation thereof, the specific position of the reality environment (i.e. a position and posture (direction) of, for example, a marker disposed in the reality environment, a specific position and posture (direction) such as a position of a part in a specific shape) is detected by the specific position detecting device. The specific position detecting device includes an imaging device such as, for example, a camera, and detects the specific position on the basis of an image of the reality environment imaged by the imaging device. The specific position detecting device may include, for example, a magnetic sensor, an ultrasonic sensor, a gyro, an acceleration sensor, an angular velocity sensor, a global positioning system (GPS), a wireless communication apparatus or the like, instead of or in addition to the imaging device. If the specific position is specified by the specific position detecting device, the additional information such as, for example, CG and letters is displayed at a position according to the detected specific position, on the display unit. This makes it possible to realize the mixed reality in which the additional information which does not exist in the reality environment looks real in the reality environment.

Particularly in the present invention, there is provided the updating device which performs the updating of the calibration data for performing the transformation from the coordinate system of the specific position detecting device to the coordinate system of the display unit, in accordance with the mounting state detected by the mounting state detecting device.

Now, for example, if the mounting state of the mounting unit changes and a positional relation thus changes between the eye of the user and the display unit, then, the display position which should correspond to the specific position changes in order to realize the mixed reality. Thus, if no measures are taken, the change in the mounting state of the mounting unit likely makes it difficult to realize the mixed reality.

Particularly in the present invention, however, the updating device performs the updating of the calibration data in accordance with the mounting state detected by the mounting state detecting device. The mounting state detecting device has, for example, a pressure distribution sensor which is disposed in the mounting unit of the head mounted display and which is configured to detect the distribution of pressure applied to the head of the user, and detects the mounting state on the basis of the distribution of the pressure detected by the pressure distribution sensor. The “updating of the calibration data” in the present invention is a process regarding the updating of the calibration data, and includes, for example, a process of updating the calibration data on the basis of the calibration data stored in a database (i.e. automating updating of the calibration data), a process of informing the user that the calibration data is to be updated (i.e. encouragement processing of the recalibration), and the like.

Thus, for example, even if the mounting state of the mounting unit changes and the positional relation thus changes between the eye of the user and the display unit, the mixed reality can be preferably realized by performing the updating of the calibration data (the automatic updating of the calibration data and the encouragement processing of the recalibration).

As explained above, according to the mixed reality apparatus of the present invention, the mixed reality can be preferably realized.

In one aspect of the mixed reality apparatus of the present invention, the mixed reality apparatus according to claim 1, wherein said mounting state detecting device has a pressure distribution sensor which is disposed in the mounting unit and which is configured to detect distribution of pressure applied from the head, and detects the mounting state on the basis of the distribution of the pressure detected by the pressure distribution sensor.

According to this aspect, the mounting state of the mounting unit of the head mounted display can be detected, highly accurately, on the basis of the distribution of the pressure detected by the pressure distribution sensor, and the updating of the calibration data can be performed at an appropriate time. Thus, the mixed reality can be realized, more preferably.

Incidentally, the mounting state detecting device may have, for example, a camera or a distance sensor disposed in the head mounted display inwardly (i.e. toward the user side), and may detect the mounting state on the basis of an image or video taken by the camera, or a distance measured by the distance sensor.

In another aspect of the mixed reality apparatus of the present invention, the mixed reality apparatus according to claim 2, wherein said mounting state detecting device further has a motion detecting device which is configured to detect a motion of the mounting unit, and detects the mounting state on the basis of the distribution of the pressure detected by the pressure distribution sensor and the motion detected by the motion detecting device.

According to this aspect, the mounting state detecting device detects, for example, the motion of the mounting unit (e.g. velocity, acceleration, or a distance at which the mounting unit moves) by using the motion detecting device.

Here, for example, force is applied when the head mounted display performs an accelerated motion, and the distribution of the pressure is thus different from that in a state of rest. Thus, when the head mounted display performs the accelerated motion, it is likely falsely detected that the mounting state has changed.

According to this aspect, however, the mounting state is detected on the basis of the distribution of the pressure detected by the pressure distribution sensor and the motion detected by the motion detecting device. It is thus possible to prevent the false detection of the mounting state.

For example, when high acceleration is detected by the motion detecting device, the mounting state detecting device places a high value on a threshold value, which is a standard for determining that the mounting state has changed. This makes it possible to prevent the false detection that a variation in the detected value of the pressure distribution sensor (i.e. the detected distribution of the pressure) caused by the accelerated motion is falsely detected to be the change in the mounting state.

Alternatively, for example, if the acceleration detected by the motion detecting device is greater than or equal to predetermined acceleration, there is a possibility that the mounting state is not accurately detected by the mounting state detecting device. Thus, the detection of the mounting state by the mounting state detecting device may be stopped so that the updating of the calibration data is not performed.

In another aspect of the mixed reality apparatus of the present invention, the mixed reality apparatus according to claim 1, further comprising: a calibration data storing device which is configured to store therein the calibration data, said updating device performs updating of the calibration data on the basis of the calibration data stored in the calibration data storing device, as the updating.

According to this aspect, the calibration data is updated on the basis of the calibration data stored in the calibration data storing device, which reduces the operation of the user for updating the calibration data. It is thus extremely useful in practice.

In another aspect of the mixed reality apparatus of the present invention, the mixed reality apparatus according to claim 1, wherein said updating device performs informing the user that the calibration data is to be updated, as the updating.

According to this aspect, the user can learn that the calibration data is to be updated, which allows the calibration data to be updated in accordance with the user's instruction. Therefore, the mixed reality can be realized, more preferably.

### Embodiment

Hereinafter, an embodiment of the present invention will be explained with reference to the drawings.

### First Embodiment

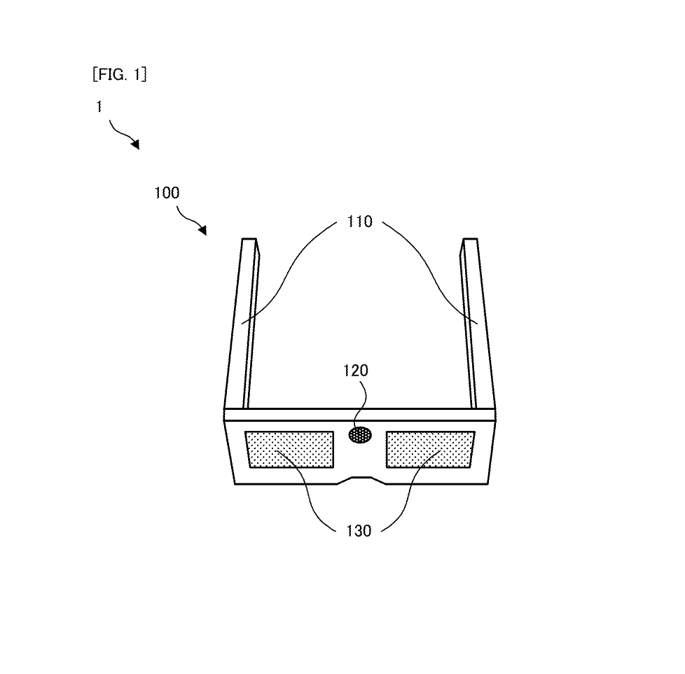

A mixed reality apparatus in a first embodiment will be explained with reference to FIG. 1 to FIG. 9.

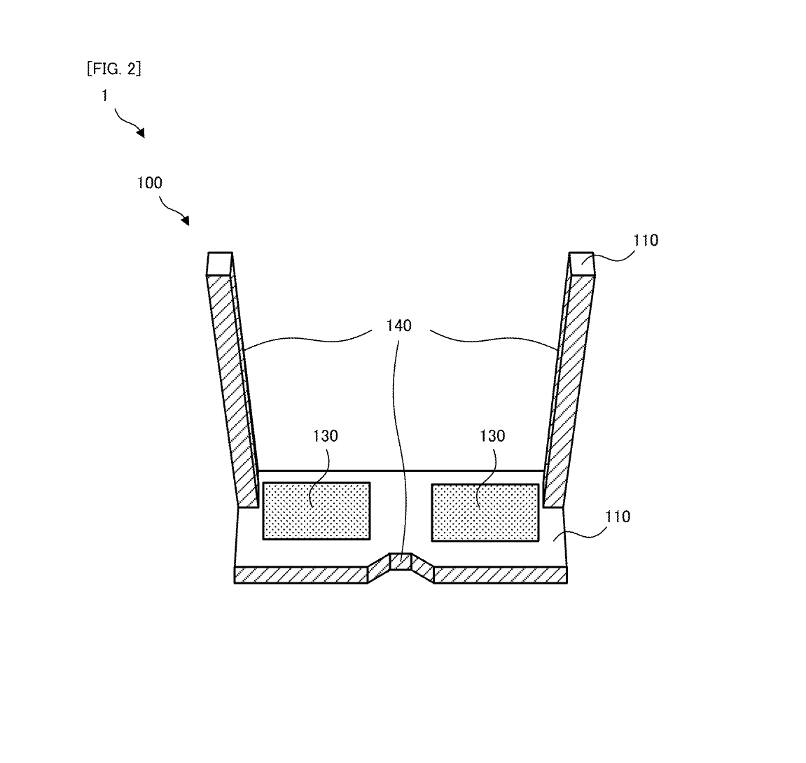

Firstly, a schematic configuration of the mixed reality apparatus in the embodiment will be explained with reference to FIG. 1 and FIG. 2.

FIG. 1 and FIG. 2 are an outside views illustrating the schematic configuration of the mixed reality apparatus in the embodiment.

In FIG. 1, a mixed reality apparatus 1 in the embodiment is an optical transmission type mixed reality apparatus, and is provided with a head mounted display 100 (hereinafter referred to as a “HMD 100”, as occasion demands) having a mounting unit 110, an imaging unit 120 and display units 130. A user uses the mixed reality apparatus 1 with the HMD 100 mounted thereon. The mixed reality apparatus 1 displays CG as one example of “additional information” of the present invention on the display units 130 so as to correspond to the position of a marker disposed in the reality environment, thereby realizing mixed reality. Incidentally, the HMD 100 is one example of the “head mounted display” of the present invention.

The mounting unit 110 is a member which is configured to be mounted on a head of the user (a glassframe-shaped member), and is configured to hold the head of the user therebetween. Incidentally, the mounting unit 110 is one example of the “mounting unit” of the present invention.

The imaging unit 120 includes a camera, and takes an image of the reality environment ahead of the user while the user wears the HMD 100. The imaging unit 120 is disposed between two display units 130 arranged on left and right sides. Incidentally, the imaging unit 120 and a marker detection unit 231 described later constitute one example of the “specific position detecting device” of the present invention. Moreover, in the embodiment, the position of the marker is detected on the basis of the image taken by the imaging unit 120; however, instead of the imaging unit 120 including the camera, the position of the marker may be detected by a magnetic sensor, an ultrasonic sensor, a gyro, an acceleration sensor, an angular velocity sensor, a GPS, a wireless communication apparatus, or the like.

The display unit 130 is a display apparatus having optical transparency. The two display units 130 are provided correspondingly to the left and right eyes of the user, respectively. The user sees the reality environment via the display units 130 and sees the CG displayed on the display units 130, thereby feeling as if the CG, which does not exist in the reality environment, existed in the reality environment. The display unit 130 is one example of the “display unit” of the present invention. The display units 130 are disposed integrally with the mounting unit 110. Thus, even if the mounting state of the mounting unit 110 changes, a positional relation between the display units 130 and the mounting unit 110 does not change.

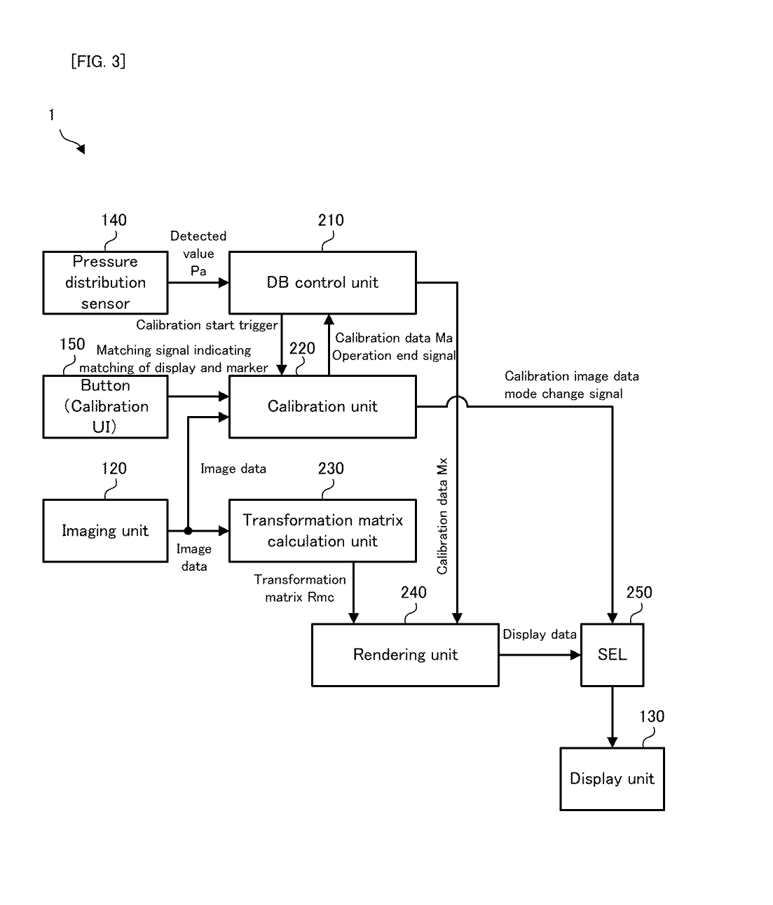

In FIG. 2, particularly in the embodiment, a pressure distribution sensor 140 is disposed in portions of the mounting unit 110 which come into contact with the user. The pressure distribution sensor 140 is a sensor for detecting the distribution of pressure applied to the mounting unit 110 from the head of the user, and outputs a detected value to a DB control unit 210 described later with reference to FIG. 3. The pressure distribution sensor 140 constitutes the “mounting state detecting device” of the present invention. The distribution of the pressure applied to the mounting unit 110 from the head of the user varies depending on the mounting state of the mounting unit 110. Thus, the detected value of the pressure distribution sensor 140 corresponds to the mounting state of the mounting unit 110.

Next, a detailed configuration of the mixed reality apparatus 1 will be explained with reference to FIG. 3 to FIG. 7.

FIG. 3 is a block diagram illustrating the configuration of the mixed reality apparatus 1.

In FIG. 3, the mixed reality apparatus 1 is provided with a button 150, a database (DB) control unit 210, a calibration unit 220, a transformation matrix calculation unit 230, a rendering unit 240, and a selector (SEL) 250, in addition to the imaging unit 120, the display unit 130, and the pressure distribution sensor 140 which are described above with reference to FIG. 1 and FIG. 2.

The button 150 is a button as a user interface (UI) for calibration, and outputs a matching signal indicating that the user considers that a calibration image (e.g. a cross-shaped image) displayed on the display unit 130 matches the marker in the reality environment, at the time of calibration for calibrating a display position of the CG on the display unit 130. The matching signal outputted from the button 150 is inputted to the calibration unit 220 described later. In the calibration, when the position of the calibration image displayed on the display unit 130 matches the position of the marker in the reality environment, the user uses the button 150 to inform the calibration unit 220 of the matching.

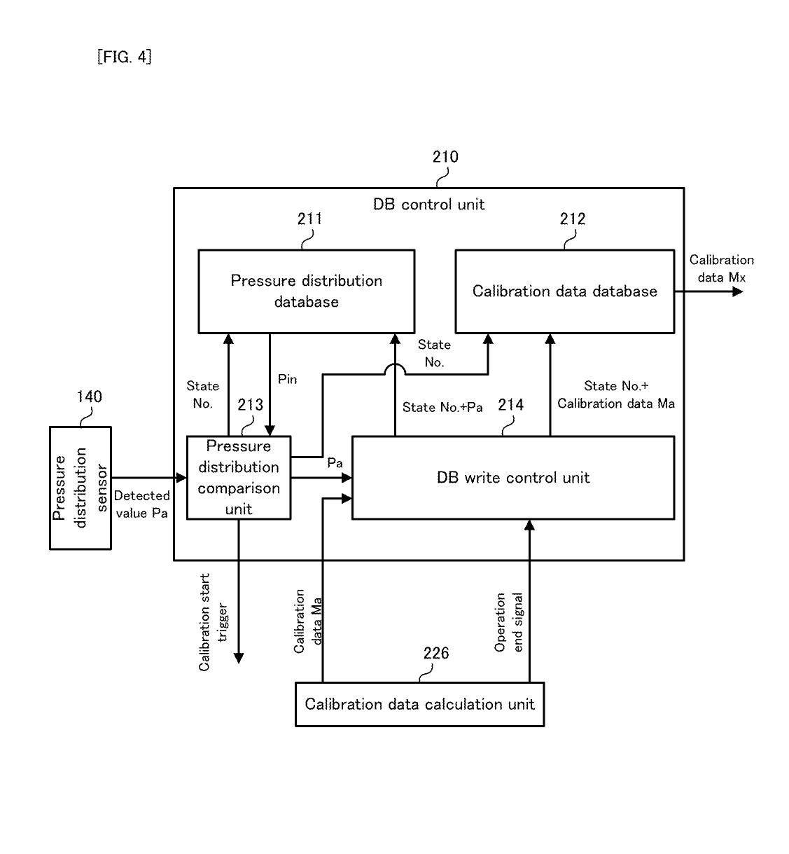

FIG. 4 is a block diagram illustrating a configuration of the DB control unit 210.

In FIG. 4, the DB control unit 210 has a pressure distribution database 211, a calibration data database 212, a pressure distribution comparison unit 213, and a DB write control unit 214.

The pressure distribution database 211 is a database for storing therein the detected value (detected pressure) detected by the pressure distribution sensor 140 in association with a state number (state No.). The detected value of the pressure distribution sensor 140 and the state No. are written into the distribution pressure database 211 by the DB write control unit 214 described later. The pressure distribution database 211 stores the detected value and the state No. for each user. In other words, the data stored in the pressure distribution database 211 is managed for each user. The same applies to the calibration data database 212 described later. The management of the data stored in the pressure distribution database 211 and the calibration data database 212 for each user enables the calibration suitable for each user. In the embodiment, a current detected value of the pressure distribution sensor 140 is referred to as a detected value Pa, as occasion demands.

The calibration data database 212 is one example of the “calibration data storing device” of the present invention, and is a database for storing therein calibration data calculated by the calibration unit 220 in association with the state No. The calibration data database 212 stores therein the calibration data and the state No. for each user. The calibration data calculated by the calibration unit 220 and the state No. are written into the calibration data database 212 by the DB write control unit 214 described later. In the embodiment, the calibration data calculated by the calibration unit 220 is referred to as calibration data Ma.

The pressure distribution comparison unit 213 compares the current detected value Pa of the pressure distribution sensor 140 with the detected values stored in the pressure distribution database 211, and determines whether or not they match. If there is a detected value that matches the current detected value Pa of the pressure distribution sensor 140 among the detected values stored in the pressure distribution database 211, the pressure distribution comparison unit 213 outputs the state No. associated with the matched detected value, to the calibration data database 212. Moreover, if there is no detected value that matches the current detected value Pa of the pressure distribution sensor 140 among the detected values stored in the pressure distribution database 211, the pressure distribution comparison unit 213 outputs a calibration start trigger which indicates that the calibration is to be started, to the calibration unit 220. Moreover, the pressure distribution comparison unit 213 outputs the current detected value Pa of the pressure distribution sensor 140 to the DB write control unit 214.

The pressure distribution comparison unit 213 uses the following equation (1) to calculate a value Q, and determines whether or not the current detected value of the pressure distribution sensor 140 matches any of the detected values stored in the pressure distribution database 211 on the basis of the value Q. In the equation (1), xᵢ is the current detected value of the pressure distribution sensor 140, and yᵢ is the detected value(s) stored in the pressure distribution database 211.

$$\begin{matrix}[ Equation 1 ] & \\ Q = \frac{\sqrt{( {\sum }_{i} {( {y}_{i} - {x}_{i} )}^{2} )}}{{\sum }_{i} {y}_{i}} & Equation ( 1 )\end{matrix}$$

If the value Q is less than or equal to a predetermined threshold value, the pressure distribution comparison unit 213 determines that the current detected value of the pressure distribution sensor 140 matches any of the detected values stored in the pressure distribution database 211. The value Q corresponds to a distance between the current detected value of the pressure distribution sensor 140 and the detected value(s) stored in the pressure distribution database 211.

Incidentally, the embodiment exemplifies that it is determined on the basis of the value Q whether or not the current detected value of the pressure distribution sensor 140 matches any of the detected values stored in the pressure distribution database 211; however, the method of determining whether or not to match is not particularly limited. For example, it may be determined whether or not to match on the basis of a correlation coefficient which indicates a correlation between the current detected value of the pressure distribution sensor 140 and the detected values stored in the pressure distribution database 211 (or a similarity in pressure distribution). In this case, even if an absolute value of the current detected value of the pressure distribution sensor 140 is different from those of the detected value(s) stored in the pressure distribution database 211, it can be determined that they match, and it can be determined that the mounting state of the mounting unit 110 is the same. Moreover, the detected value of the pressure distribution sensor 140 may be coded (or quantized). In this case, it is determined on the basis of the coded detected value whether or not the current detected value of the pressure distribution sensor 140 matches any of the detected values stored in the pressure distribution database 211, by which it is possible to speed up the determination.

The DB write control unit 214 writes the current detected value Pa of the pressure distribution sensor 140 into the pressure distribution database 211 and writes the calibration data Ma calculated by the calibration unit 220 into the calibration data database 212 when an operation end signal is inputted from the calibration unit 220. At this time, the DB write control unit 214 writes the detected value Pa and the calibration data Ma into the pressure distribution database 211 and the calibration unit 220, respectively, in association with the state No.

Incidentally, in the embodiment, if the current detected value Pa of the pressure distribution sensor 140 is not stored in the pressure distribution database 211, the detected value Pa is added to the pressure distribution database 211 with the state No., and at the same time, the calibration data Ma calculated by the calibration unit 220 when the detected value of the pressure distribution sensor 140 is the detected value Pa (in other words, the calibration data Ma determined by performing the calibration when the detected value of the pressure distribution sensor 140 is the detected value Pa) is added to the calibration data database 212 in association with the state No. (i.e. in association with the detected value Pa).

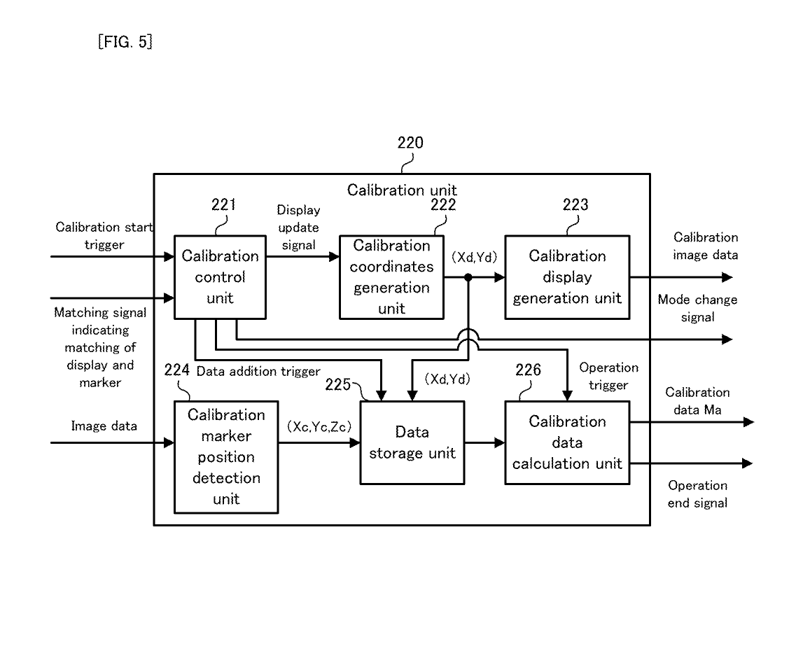

FIG. 5 is a block diagram illustrating a configuration of the calibration unit 220.

In FIG. 5, the calibration unit 220 performs the calibration if the calibration start trigger is inputted from the DB control unit 210 described above (more specifically, the pressure distribution comparison unit 213), thereby calculating the calibration data. The calibration unit 220 has a calibration control unit 221, a calibration coordinates generation unit 222, a calibration display generation unit 223, a calibration marker position detection unit 224, a data storage unit 225, and a calibration data calculation unit 226.

The calibration control unit 221 controls the calibration. Specifically, the calibration control unit 221 controls the operation of the calibration coordinates generation unit 222, the calibration marker position detection unit 224, and the calibration data calculation unit 226. The calibration control unit 221 starts the calibration if the calibration start trigger is inputted from the DB control unit 210. For example, if the calibration start trigger is inputted from the DB control unit 210, the calibration control unit 221 outputs a display update signal to the calibration coordinates generation unit 222 and outputs a data addition trigger to the data storage unit 225, in accordance with the matching signal from the button 150. If the matching signal from the button 150 is inputted a predetermined number of times, the calibration control unit 221 outputs an operation trigger to the calibration data calculation unit 226 and outputs a mode change signal to the selector 250. As described later, if the operation trigger is inputted, the calibration data calculation unit 226 calculates the calibration data Ma. Moreover, if the mode change signal is inputted, the selector 250 performs mode change in which data to be outputted to the display unit 130 is changed between calibration image data and display data. Here, in the calibration, the user moves a calibration plate which is provided with a calibration marker such that the calibration marker matches the calibration image (e.g. the cross-shaped image) displayed on the display unit 130, and enables the button 150 to output the matching signal when the calibration marker matches the calibration image. In the calibration, the calibration plate may be moved, or the HMD 100 may be moved. Moreover, the calibration is not particularly limited; for example, the calibration may be performed such that a two-dimensional object, such as a quadrangle, in the reality environment matches a two-dimensional display, such as a quadrangle, on the display unit 130, or the calibration may be performed such that a three-dimensional object in the reality environment matches a three-dimensional display on the display unit 130. Moreover, the calibration may be performed by fixing the calibration plate which is provided with the calibration marker and by changing the position, size, posture, and the like of the calibration image to be displayed on the display unit 130, to detect the matching of the calibration marker and the calibration image.

The calibration coordinates generation unit 222 generates coordinates (Xd, Yd) to display the calibration image on the display unit 130 if the display update signal is inputted from the calibration control unit 221. The calibration coordinates generation unit 222 outputs the generated coordinates (Xd, Yd) to the calibration display generation unit 223 and the data storage unit 225.

The calibration display generation unit 223 generates image data of the calibration image (e.g. the cross-shaped image) to be displayed on the coordinates (Xd, Yd) generated by the calibration coordinates generation unit 222 (hereinafter referred to as “calibration image data” as occasion demands). The calibration display generation unit 223 outputs the generated calibration image data to the selector 25—(refer to FIG. 3).

The calibration marker position detection unit 224 detects the position of the calibration marker from the image taken by the imaging unit 120. Specifically, the calibration marker position detection unit 224 specifies coordinates (Xc, Yc, Zc) which indicates the position of the calibration marker on the basis of image data inputted from the imaging unit 120, and outputs the specified coordinates (Xc, Yc, Zc) to the data storage unit 225.

The data storage unit 225 stores the coordinates (Xd, Yd) inputted from the calibration coordinates generation unit 222 and the coordinates (Xc, Yc, Zc) inputted from the calibration marker position detection unit 224 in association with each other, when the data addition trigger is inputted from the calibration control unit 221. The data storage unit 225 generates and holds a data list in which the coordinates (Xd, Yd) are associated with the coordinates (Xc, Yc, Zc), wherein the coordinates (Xd, Yd) are the position coordinates of the marker based on the coordinate system of the display unit 130, and the coordinates (Xc, Yc, Zc) are the position coordinates of het marker based on the coordinate system of the imaging unit 120.

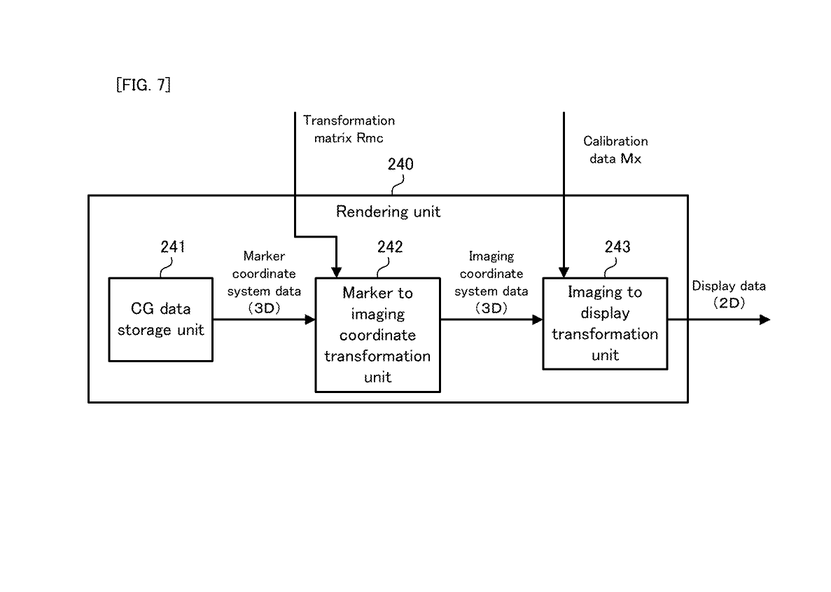

The calibration data calculation unit 226 calculates the calibration data Ma on the basis of the coordinates (Xd, Yd) and the coordinates (Xc, Yc, Zc) which are stored in the data storage unit 225, if the operation trigger is inputted from the calibration control unit 221. The calibration data Ma is data for calibrating a relation between the coordinate system of the imaging unit 120 and the coordinate system of the display unit 130. The rendering unit 240 described later with reference to FIG. 7 (more specifically, an imaging to display transformation unit 243) transforms display data (CG data) from the coordinate system of the imaging unit 120 to the coordinate system of the display unit 130 (coordinate transformation and projection transformation), on the basis of the calibration data Ma. After the calculation of the calibration data Ma, the calibration data calculation unit 226 outputs an operation end signal which indicates the end of the calculation, to the calibration control unit 221.

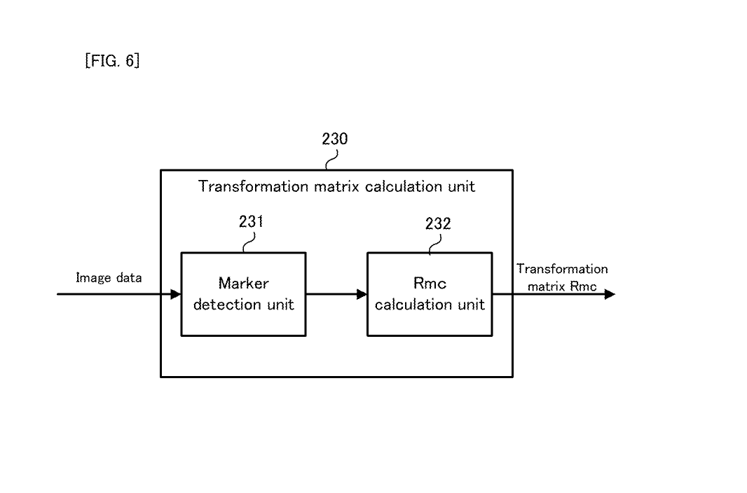

FIG. 6 is a block diagram illustrating a configuration of the transformation matrix calculation unit 230.

In FIG. 6, the transformation matrix calculation unit 230 has a marker detection unit 231 and a Rmc calculation unit 232.

The marker detection unit 231 detects the position and size of the marker in the image taken by the imaging unit 120.

The Rmc calculation unit 232 calculates a transformation matrix Rmc for the transformation from the coordinate system of the marker to the coordinate system of the imaging unit 120, on the basis of the position and size of the marker detected by the marker detection unit 231. The Rmc calculation unit 232 outputs the calculated transformation matrix Rmc to the rendering unit 240. The transformation matrix Rmc is updated, by which the CG is displayed on the display unit 130 to follow the marker.

FIG. 7 is a block diagram illustrating a configuration of the rendering unit 240.

In FIG. 7, the rendering unit 240 performs rendering regarding the CG to be displayed on the display unit 130. The rendering unit 240 has a CG data storage unit 241, a marker to imaging coordinate transformation unit 242, and the imaging to display transformation unit 243.

The CG data storage unit 241 is a storing device in which the data of the CG to be displayed on the display unit 130 (CG data) is stored. The CG data storage unit 241 stores therein the CG data in the coordinate system of the marker. The CG data stored in the CG data storage unit 241 is three-dimensional (3D) data. Hereinafter, the CG data stored in the CG data storage unit 241 will be referred to as “marker coordinate system data”, as occasion demands.

The marker to imaging coordinate transformation unit 242 transforms the C data stored in the CG data storage unit 241 from the coordinate system of the marker and the coordinate system of the imaging unit 120, on the basis of the transformation matrix Rmc inputted from the transformation matrix calculation unit 230. Hereinafter, the CG data based on the coordinate system of the imaging unit 120 after being transformed by the marker to imaging coordinate transformation unit 242 will be referred to as “imaging coordinate system data”, as occasion demands.

The imaging to display transformation unit 243 transforms the imaging coordinate system data inputted from the marker to imaging coordinate transformation unit 242, to the display data (coordinate transformation and projection transformation) on the basis of calibration data Mx inputted from the calibration data database 212. The display data is two-dimensional (2D) data based on the coordinate system of the display unit 130. The imaging to display transformation unit 243 outputs the display data to the selector 250 (refer to FIG. 3).

In FIG. 3, the selector 250 selectively outputs the calibration image data inputted from the calibration unit 220 and the display data inputted from the rending unit 240, to the display unit 130. The selector 250 outputs the calibration image data to the display unit 130 when the calibration is performed, and outputs the display data to the display unit 130 when the CG is to be displayed on the display unit 130. The display unit 130 displays the calibration image (e.g. the cross-shaped image) on the basis of the calibration image data, and displays the CG on the basis of the display data.

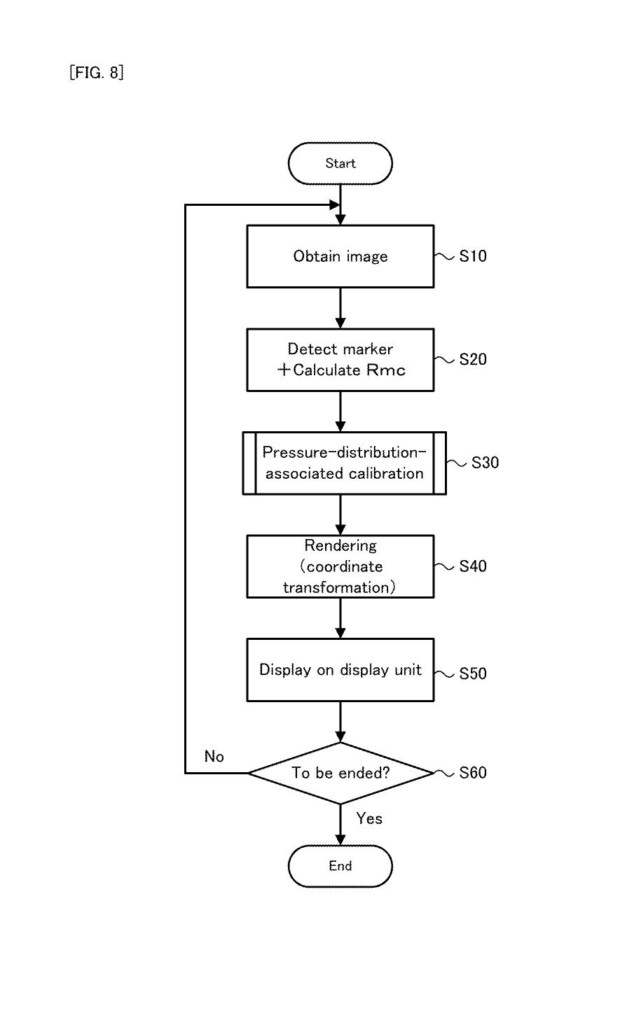

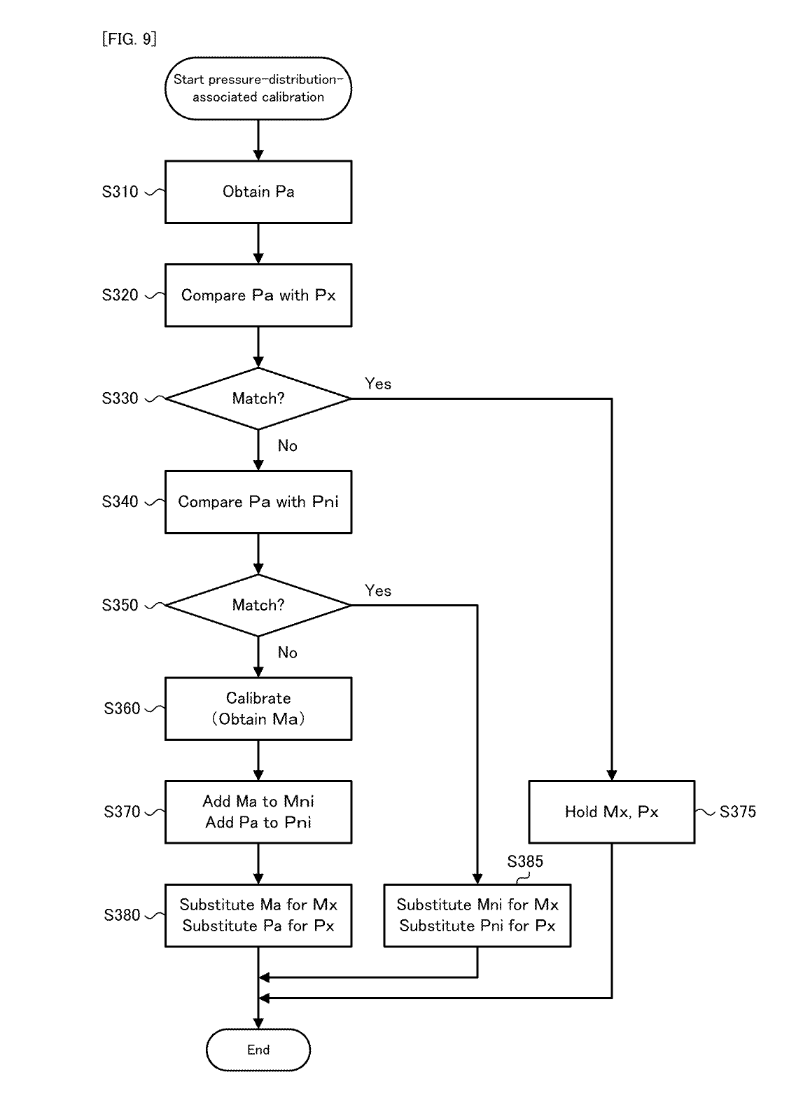

Next, the operation of the mixed reality apparatus 1 will be explained with reference to FIG. 8 and FIG. 9.

FIG. 8 is a flowchart illustrating a flow of the operation of the mixed reality apparatus 1.

In FIG. 8, firstly, the image of the reality environment is obtained by the imaging unit 120 (step S10). In other words, the mixed reality apparatus 1 takes the image of the reality environment with the imaging unit 120, thereby obtaining the image of the reality environment.

Then, the marker is detected by the transformation matrix calculation unit 230, and the transformation matrix Rmc is calculated (step S20). In other words, the marker detection unit 231 of the transformation matrix calculation unit 230 detects the position, posture (direction) and size of the marker disposed in the reality environment on the basis of the image of the reality environment obtained by the imaging unit 120, and the Rmc calculation unit 232 of the transformation matrix calculation unit 230 calculates the transformation matrix Rmc on the basis of the detected position, posture (direction) and size of the marker.

Then, pressure-distribution-associated calibration is performed (step S30).

FIG. 9 is a flowchart illustrating a flow of the pressure-distribution-associated calibration.

In FIG. 9, in the pressure-distribution-associated calibration, firstly, the current detected value Pa of the pressure distribution sensor 140 (refer to FIG. 2 and FIG. 3) is obtained by the pressure distribution comparison unit 213 (refer to FIG. 4) (step S310).

Then, the obtained detected value Pa is compared with a detected value Px of the pressure distribution sensor 140 when the currently used calibration data Mx is calculated, by the pressure distribution comparison unit 213 (step S320).

Then, it is determined by the pressure distribution comparison unit 213 whether or not the current detected value Pa of the pressure distribution sensor 140 matches the detected value Px of the pressure distribution sensor 140 when the currently used calibration data Mx is calculated (step S330).

If it is determined that the detected value Pa matches the detected value Px (the step S330: Yes), the calibration data Mx and the detected value Px are held (step S375). If the detected value Pa matches the detected value Px, the mounting state of the HMD 100 (more specifically, the mounting unit 110 thereof) is almost or completely the same between the present time and when the calibration data Mx is calculated, and the positional relation between the eyes of the user and the display unit(s) 130 hardly changes or does not change at all. Thus, the mixed reality can be preferably realized by transforming the imaging coordinate system data to the display data with the imaging to display transformation unit 243 (refer to FIG. 7) on the basis of the currently used calibration data Mx.

If it is determined that the detected value Pa does not match the detected value Px (the step S330: No), the current detected value Pa of the pressure distribution sensor 140 is compared with detected values Pni stored in the pressure distribution database 211, by the pressure distribution comparison unit 213 (step S340).

Then, it is determined by the pressure distribution comparison unit 213 whether or not the current detected value Pa of the pressure distribution sensor 140 matches any of the detected values Pni stored in the pressure distribution database 211 (step S350). In other words, the pressure distribution comparison unit 213 determines whether or not there is a detected value Pni that matches the current detected value Pa of the pressure distribution sensor 140, among the detected values Pni stored in the pressure distribution database 211.

If it is determined that the detected value Pa matches any of the detected values Pni (the step S350: Yes), the currently used calibration data Mx is changed to calibration data Mni corresponding to the detected value Pni, and the detected value Px is changed to the detected value Pni. The calibration data Mni is calibration data calculated by the calibration unit 220 when the detected value of the pressure distribution sensor 140 is the detected value Pni, and is stored in the calibration data database 212 in association with the same state No. as that of the detected value Pni. If the detected value Pa matches any of the detected value Pni, the mounting state of the HMD 100 (more specifically, the mounting unit 110 thereof) is almost or completely the same between the present time and when the calibration data Mni is calculated, and the positional relation between the eyes of the user and the display unit(s) 130 hardly changes or does not change at all. Thus, the mixed reality can be preferably realized by transforming the imaging coordinate system data to the display data with the imaging to display transformation unit 243 (refer to FIG. 7) on the basis of the calibration data Mni.

If it is determined that the detected value Pa does not match any of the detected values Pni (the step S350: No), the calibration is performed, and the calibration data Ma is obtained (step S360). In other words, in this case (the step S350: No), the calibration is performed by the calibration unit 220, and new calibration data Ma is calculated.

Then, the calibration data Ma is added to the calibration data database 212, and the detected value Pa is added to the pressure distribution database 211 (step S370). In other words, the calibration data Ma newly calculated by the calibration data calculation unit 226 of the calibration unit 220 (refer to FIG. 5) is inputted to the DB write control unit 214 of the DB control unit 210, and is written into the calibration data database 212 by the DB write control unit 214. At this time, the current detected value Pa of the pressure distribution sensor 140 is written into the pressure distribution database 211 by the DB write control unit 214. In other words, in the embodiment, if the detected value that matches the current detected value Pa of the pressure distribution sensor 140 is not stored in the pressure distribution database 211, the calibration is newly performed to calculate the new calibration data Ma, and the detected value Pa and the calibration data Ma are added to the pressure distribution database 211 and the calibration data database 212, respectively.

Then, the currently used calibration data Mx is changed to the new calibration data Ma corresponding to the current detected value Pa of the pressure distribution sensor 140, and the detected value Px is changed to the detected value Pa (step S380).

As described above, in the pressure-distribution-associated calibration, (i) if the current detected value Pa of the pressure distribution sensor 140 matches the detected value Px corresponding to the currently used calibration data Mx, the calibration data is held without change, (ii) if the current detected value Pa of the pressure distribution sensor 140 matches any of the detected values Pni stored in the pressure distribution database 211, the calibration data is changed to the calibration data Mni corresponding to the detected value Pni, and (iii) if the current detected value Pa of the pressure distribution sensor 140 does not match the detected value Px corresponding to the currently used calibration data Mx and if there is no detected value that matches the current detected value Pa of the pressure distribution sensor 140 in the pressure distribution database 211, the new calibration data Ma is calculated by newly performing the calibration, and the detected value Pa and the calibration data Ma are added to the pressure distribution database 211 and the calibration data database 212, respectively.

In FIG. 8, after the pressure-distribution-associated calibration, the rendering is performed in which the display data of the CG to be displayed on the display unit 130 is generated (step S40). In the rendering, firstly, the marker coordinate system data stored in the CG data storage unit 241 is transformed to the imaging coordinate system data by the marker to imaging coordinate transformation unit 242 on the basis of the transformation matrix Rmc. Then, the imaging coordinate system data is transformed to the display data by the imaging to display transformation unit 243 on the basis of the calibration data Mx. The display data generated in this manner is inputted to the display unit 130 via the selector 250 (refer to FIG. 3).

Then, the CG based on the display data is displayed on the display unit 130 (step S50).

Then, it is determined whether or not the display of the CG on the display unit 130 is to be ended (step S60).

If it is determined that the display is to be ended (the step S60: Yes), the display of the CG is ended.

If it is determined that the display is not to be ended (the step S60: No), the processing in the step S10 is performed again.

Incidentally, the embodiment exemplifies that processing from the step S10 to the step S60 is continuously performed; however, the pressure-distribution-associated calibration (step S30) may be performed in parallel with the other processing.

Particularly in the embodiment, as described above, if the current detected value Pa of the pressure distribution sensor 140 matches any of the detected values Pni stored in the pressure distribution database 211, the calibration data Mx is changed to the calibration data Mni corresponding to the detected value Pni (step S385). Thus, the imaging coordinate system data can be transformed to the display data by the imaging to display transformation unit 243 on the basis of the calibration data Mni suitable for the current mounting state of the HMD 100, without newly performing the calibration. Therefore, it is possible to eliminate a time required for the calibration and the operation of the user, and to preferably realize the mixed reality.

Moreover, particularly in the embodiment, as described above, if the current detected value Pa of the pressure distribution sensor 140 does not match the detected value Px corresponding to the currently used calibration data Mx and if there is no detected value that matches the current detected value Pa of the pressure distribution sensor 140 in the pressure distribution database 211, the new calibration data Ma is calculated by newly performing the calibration, and the detected value Pa and the calibration data Ma are added to the pressure distribution database 211 and the calibration data database 212, respectively (the steps S360, S370 and S380). Thus, it is possible to detect that the current mounting state of the HMD 100 is different from the mounting state of the HMD 100 when the currently used calibration data Mx is calculated, and to certainly perform the new calibration. The appropriate calibration data Ma can be calculated by the new calibration, and thus, the mixed reality can be preferably performed. Moreover, the detected value Pa and the calibration data Ma are added to the pressure distribution database 211 and the calibration data database 212, respectively. Thus, after that, if the detected value of the pressure distribution sensor 140 matches the detected value Pa, the imaging coordinate system data is transformed to the display data by the imaging to display transformation unit 243 on the basis of the calibration data Ma corresponding to the detected value Pa. By this, the mixed reality can be preferably realized without performing the calibration.

As a modified example, in FIG. 9, if it is determined that the detected value Pa does not match any of the detected values Pni (the step S350: No), processing in which the user is informed that the calibration data is to be updated may be performed instead of the processing in the step S360 (i.e. the calibration). In this case, the user can know that the calibration data is to be updated. The calibration is performed in accordance with the user's instruction to update the calibration data, by which the mixed reality can be preferably realized.

As another modified example, there may be provided a motion detecting device which includes an accelerator sensor or a gyro sensor and which is configured to detect a motion of the mounting unit 110, in addition to the pressure distribution sensor 140. For example, when high acceleration is detected by the motion detecting device, a high value can be placed on a pressure threshold value, which is a standard for determining that the mounting state of the mounting unit 110 has changed. This makes it possible to prevent the false detection that a variation in the detected value of the pressure distribution sensor (i.e. the detected distribution of the pressure) caused by an accelerated motion is falsely detected to be the change in the mounting state of the mounting unit 110.

Alternatively, for example, if the acceleration detected by the motion detecting device is greater than or equal to predetermined acceleration, there is a possibility that the mounting state of the mounting unit 110 is not accurately detected. Thus, the detection of the mounting state of the mounting unit 110 may be stopped so that the updating of the calibration data is not performed.

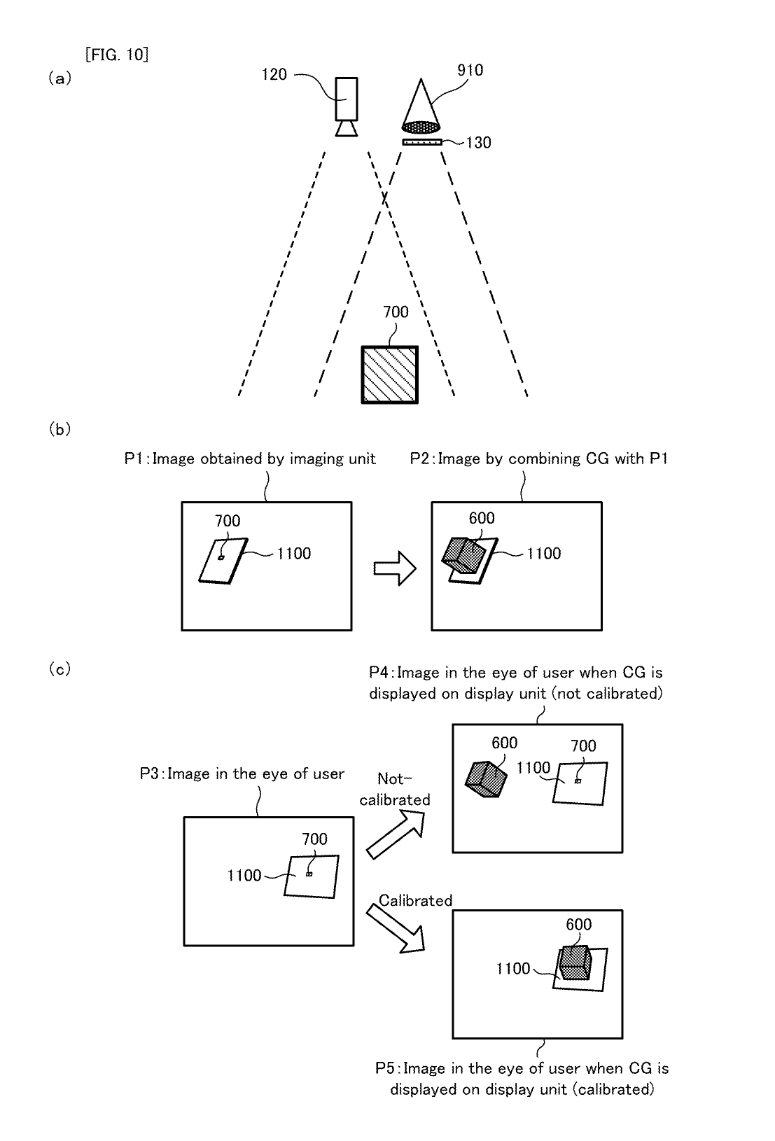

Next, the calibration in the mixed reality apparatus 1, which is the optical transmission type mixed reality apparatus, will be explained with reference to FIGS. 10.

FIG. 10 are diagrams for explaining the calibration in the mixed reality apparatus 1.

In FIG. 10(a), in the head mounted display 100 having the imaging unit 120 and the display unit 130, an image obtained by the imaging unit 120 and an image in an eye 910 of the user are different from each other because the position of the eye 910 of the user and the position of the imaging unit 120 are different from each other. For example, it is assumed that the eye 910 of the user, the imaging unit 120, and a marker 700 disposed in the reality environment are in a positional relation as illustrated in FIG. 10(a). In an image P1 obtained by the imaging unit 120 (refer to FIG. 10(b)), the marker 700 is located on the left side of the image. In an image P3 in the eye 910 of the user (refer to FIG. 10(c)), the marker 700 is located on the right side of the image. Incidentally, the marker 700 is disposed on an object 1100 in the reality environment.

Here, the position of the marker 700 is detected on the basis of the image P1 obtained by the imaging unit 120, and a CG 600 is combined at the detected position on the image P1. This makes it possible to generate an image P2 in which the position of the CG 600 matches the position of the marker 700. In the optical transmission type mixed reality apparatus such as the mixed reality apparatus 1, there is a need to perform the calibration in accordance with a difference between the position of the eye 910 of the user and the position of the imaging unit 120. If the calibration is not performed, as illustrated in an image P4 in FIG. 10(c), the position and posture (direction) of the CG 600 and those of the marker 700 likely deviate from each other when the CG 600 is displayed on the display unit 130. However, the calibration (the transformation of the imaging coordinate system data to the display data based on the calibration data in the embodiment) enables the position and posture (direction) of the CG 600 to match those of the marker 700, as illustrated in an image P5 in FIG. 10(c).

As explained above, according to the mixed reality apparatus 1 in the embodiment, the mounting state of the HMD 100 is detected on the basis of the detected value of the pressure distribution sensor 140, and the calibration data is updated in accordance with the detected mounting state. Thus, the mixed reality can be preferably realized.

The present invention is not limited to the aforementioned embodiments, but various changes may be made, if desired, without departing from the essence or spirit of the invention which can be read from the claims and the entire specification. A missed reality apparatus, which involves such changes, is also intended to be within the technical scope of the present invention.

### DESCRIPTION OF REFERENCE CODES

1 mixed reality apparatus
100 head mounted display (HMD)
110 mounting unit
120 imaging unit
130 display unit
140 pressure distribution sensor
150 button
210 DB control unit
211 pressure distribution database
212 calibration data database
213 pressure distribution comparison unit
214 DB write control unit
220 calibration unit
221 calibration control unit
222 calibration coordinates generation unit
223 calibration display generation unit
224 calibration marker position detection unit
225 data storage unit
226 calibration data calculation unit
230 transformation matrix calculation unit
240 rendering unit
250 selector

1. A mixed reality apparatus comprising:
a head mounted display having a mounting unit which is mounted on a head of a user, a specific position detecting device which is configured to detect a specific position of a reality environment, and a display unit which is configured to display additional information to be added to the reality environment;
a mounting state detecting device which is configured to detect a mounting state of the mounting unit; and
an updating device which is configured to perform updating of calibration data for performing transformation from a coordinate system of the specific position detecting device to a coordinate system of the display unit, in accordance with the mounting state detected by said mounting state detecting device.

2. The mixed reality apparatus according to claim 1, wherein said mounting state detecting device has a pressure distribution sensor which is disposed in the mounting unit and which is configured to detect distribution of pressure applied from the head, and detects the mounting state on the basis of the distribution of the pressure detected by the pressure distribution sensor.

3. The mixed reality apparatus according to claim 2, wherein said mounting state detecting device further has a motion detecting device which is configured to detect a motion of the mounting unit, and detects the mounting state on the basis of the distribution of the pressure detected by the pressure distribution sensor and the motion detected by the motion detecting device.

4. The mixed reality apparatus according to claim 1, further comprising:
a calibration data storing device which is configured to store therein the calibration data,
said updating device performs updating of the calibration data on the basis of the calibration data stored in the calibration data storing device, as the updating.

5. The mixed reality apparatus according to claim 1, wherein said updating device performs informing the user that the calibration data is to be updated, as the updating.

6. The mixed reality apparatus according to claim 1, wherein said mounting state detecting device has a distance detecting device which is disposed in the mounting unit and which is configured to detect a distance between the mounting unit and the head, and detects the mounting state on the basis of the distance between the mounting unit and the head detected by the distance detecting device.

7. The mixed reality apparatus according to claim 6, wherein the distance detecting device is a camera or a distance sensor disposed toward the head.
